(19) United States
(12) Patent Application Publication
(10) Pub. No.: US 2002/0185897 A1
(43) Pub. Date: Dec. 12, 2002

(54) Seat for bicycle device

(76) Inventor: Glenn Crutch, St. Albans, NY (US)

Correspondence Address: WILLIAM COLLARD, COLLARD & ROE, P.C., 1077 NORTHERN BOULEVARD, ROSLYN, NY, 11576, US

(21) Appl. No.: 09/877,842

(22) Filed: Jun. 8, 2001

(51) Int. Cl. B62J 1/00

(52) U.S. Cl. 297/195.1

(57) ABSTRACT

A seat for a bicycle device having rotationally mounted pedals is provided. The seat includes a buttocks support having a surface for supporting the ischial bones of a user and a base connected to the buttocks support for attachment to the bicycle device. The buttocks support surface comprises first and second sides transverse to the ischial bones of the user and third and fourth sides connecting the first and second sides. The surface provides a circumferential area approximately equal to or greater than the area occupied by the buttocks of a user when seated. The base positions the buttocks support transverse to the rotational plane of the pedals of the bicycle device.

### BACKGROUND OF THE INVENTION

1. Field of the Invention

The present invention relates to bicycle seats and more particularly to a seat for a bicycle or mechanical device using a seat for the same purpose, which allows the user to sit more comfortably.

2. The Prior Art

At the present time, there are various bicycle seat devices. For example, U.S. Pat. No. 4,613,187 to Gordon shows a bicycle seat comprising a cylindrical seat assembly to support a rider's buttocks without imparting soreness to the crotch. U.S. Pat. No. 4,717,417 to Bunker shows a bicycle seat comprising a rubber tube secured to a bracket assembly. U.S. Pat. No. 4,176,880 to Marchello shows a hammock type bicycle seat. Other bicycle seats are shown in U.S. Pat. No. 5,387,025 to Denisar and U.S. Pat. No. 6,135,550 to Tucho.

It has been noted that the traditional horned bicycle seat is damaging to genital anatomy. For example, an article written by Joe Kita entitled “Men Riding Bicycles” originally appearing in Bicycling Magazine in August 1997 and reported on ABC 20/20 Primetime Thursday, Sep. 18, 1997 discussed findings of a Dr. Goldstein, a urologist at Boston University Medical Center, who estimated that there are about 100,000 men who have lost the ability to get or maintain satisfactory erections because of damage due to the bicycle saddle or top bar. Dr. Goldstein suggested two immediate changes to the traditional bicycle seat in which a male rider puts his entire body weight on the artery that supplies the penis. The first suggested change was the use of a recumbent bike or a wider type bike seat that allows the ischial tuberosities to bear more of the body weight. The second suggested change was for the user, especially in the case of children, to be given a bicycle with a top tube and seats with no noses.

Despite these suggestions, there is still a need for a bicycle seat that provides total support and enable a more comfortable, safe and durable seating experience. Although the Gordon patent discussed above is said to support a rider's buttocks without imparting soreness to the crotch, Gordon's narrow cylindrical seat bar would not provide a comfortable ride, particularly over an extended period, and would not support both the superior aperture and the inferior aperture of a user's pelvis. The other patents show arrangements which are likewise uncomfortable, aerodynamically unsound, unduly restricting or overly complicated.

### SUMMARY OF THE INVENTION

The invention relates to a seat for a bicycle device having rotationally mounted pedals. The device has a buttocks support including a surface for supporting the ischial bones of a user and a base connected to the buttocks support for attachment to the bicycle device and positioning of the buttocks support transverse to the rotational plane of the pedals. The surface of the buttocks support has first and second sides transverse to the ischial bones of the user and third and fourth sides connected to the first and second sides. The surface provides a circumferential area approximately equal to or greater than the area occupied by the buttocks of the user when seated.

Additional details of the invention are contained in the following detailed description and the attached drawings, in which preferred embodiments are illustrated by way of example.

### BRIEF DESCRIPTION OF THE DRAWINGS

Other objects and features of the present invention will become apparent from the following detailed description considered in conjunction with the accompanying drawings. It should be understood, however, that the drawings are designed for the purpose of illustration only and not as a definition of the limits of the invention.

In the drawings, wherein similar reference characters denote similar elements throughout the several views:

FIG. 1 is a perspective view of an embodiment of the present invention;

FIG. 2 is a top view of the buttocks support and cover of the embodiment of FIG. 1;

FIG. 3 is a side view of the buttocks support of the embodiment of FIG. 1; and

FIG. 4 is a perspective view of the embodiment of FIG. 1 showing the orientation of a rider and of the seat during use.

FIG. 5 is a bottom view of the embodiment of FIG. 1 showing the base and the underside of the buttocks support.

### DETAILED DESCRIPTION OF PREFERRED EMBODIMENTS

The seat for a bicycle device of the present invention is designed to eliminate the painful pressure associated with riding on a conventional saddle, and made to interact with the human pelvis. Although the human pelvis differs by sex, the seat of the present invention is specifically designed to contour the human pelvis of both male and female users. Generally, the human pelvis is designed as a “V” having two points meeting directly behind the testicles or vagina. The pelvis must be totally supported in order to promote a healthier ride. The seat of the present invention fully supports the anterior pelvic structure by supporting both the ischial pubic ramus and the ischial tuberosity bone, which rests completely on the seat and allows the pubic symphysis to be free from any pressure. A description of the human pelvis may be found, for example, in Henry Gray, Anatomy of the Human Body (1918), section 6c.2.

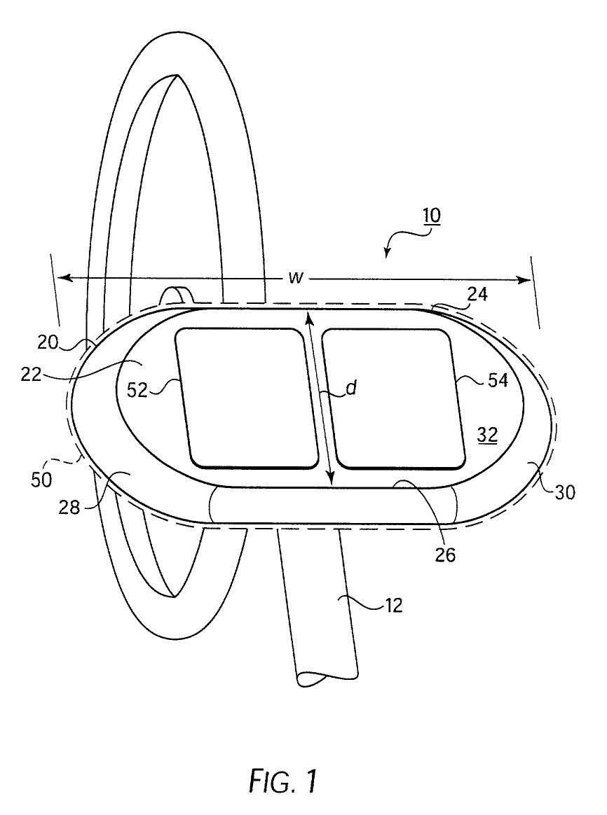

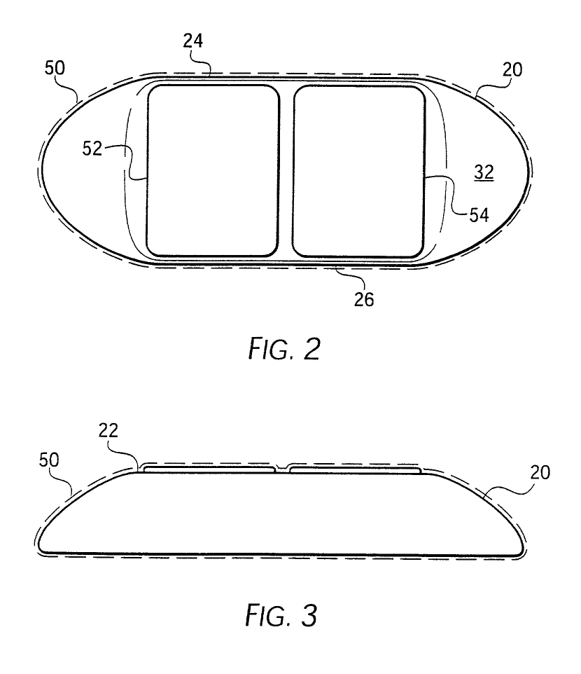

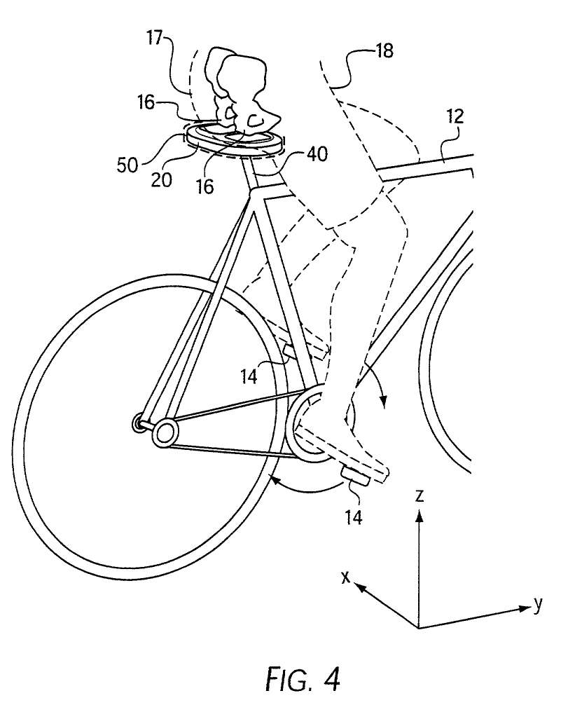

Turning now in detail to the drawings, FIGS. 1-5 show an embodiment of the seat 10 for a bicycle 12 or other mechanical device having rotationally mounted pedals 14 that would use a seat for the same purpose. For example, seat 10 could be used in a stationary bicycle exercise machine. Pedals 14 rotate in use in a rotational plane yz transverse to the direction of movement of bicycle 10 along axis y.

Seat 10 comprises a buttocks support 20 having a surface 22 for supporting the ischial bones 16 of a user 18. Preferably, buttocks support 20 has a flattened oval type circumferential design with a diameter d, for example, of 4 to 5 inches and a width w of 7 to 8 inches. Measurements would be altered for children. Surface 22 comprises first and second sides 24, 26 along an x axis transverse to ischial bones 16 and third and fourth sides 28, 30, which preferably are curved as shown in FIG. 1, connecting first and second sides 24, 26. As shown in FIG. 1, third and fourth sides 28, 30 extend in a curved path generally transverse to first and second sides 24, 26. First and second sides 24, 26 may also be curved.

Surface 22 provides a substantially level, open-sided circumferential area 32 approximately equal to or greater than the area occupied by the buttocks 17 of user 18 when seated. Preferably, circumferential area 32 is between 25 and 45 square inches and averages the total area of the pelvis. The open sides of surface 22 allow for easy mounting and dismounting and are nonrestricting to a user when seated.

Seat 10 also includes a base 60 connected to buttocks support 20 for attachment to bicycle device 12, for example by mounting on pole 40. Base 60 positions buttock support 20 across the buttocks transverse to rotational plane yz of pedals 14 with first and second sides 24, 26 along the x axis transverse to the direction of movement of bicycle 12 along the y axis.

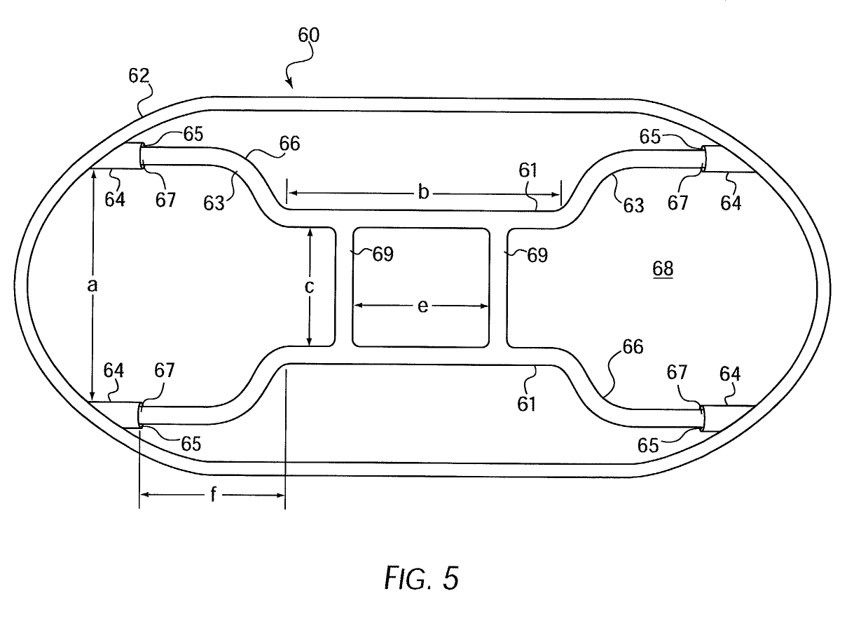

As shown in FIG. 5, base 60 preferably comprises a brim 62 connected to an underside edge of the buttocks support 20, a plurality of braces 64 connected to brim 62, and a plurality of rods 66 inserted into braces 64.

Brim 62 preferably is made of a hard plastic or similar material. Brim 62 goes around the edge of buttocks support 20 and extends underneath buttocks support 20.

Braces 64 are preferably plastic and formed onto brim 62 for support of rods 66. Preferably, four braces are used, two on each side of brim 62 as shown in FIG. 5. Each brace 64 may be designed with an opening 65 for receipt of an end 67 of a rod 66 inserted therein. Preferably braces 64 are arranged so that they are a distance a, for example between 2⅞ to 3¼ inches apart from each other on each side.

Rods 66 which are inserted inside braces 64 are preferably ¼ inches in diameter and have a soft covering made of rubber or similar material around them. Rods 66 extend across the underside 68 of buttocks support 20 for supporting the rider fully. Each rod 66 is connected to each other, for example, by smaller transverse members 69 which connect longer parallel portions 61 of rods 66. Preferably, parallel portions 61 are connected to ends 67 of rods 66 by a curved portion 63 so that the start of each parallel portion 61 is separated from the adjacent end 67 of rod 66 by a distance f, for example, between 1⅛ inches and 1¾ inches. With this arrangement, base 60 may be easily connected to bicycle device 12, preferably with a brace, such as a KALIN® brace of the Hsin Lung Accessories Co., Ltd Corporation or similar brace which holds a bicycle seat to a bicycle.

Preferably, parallel portions 61 have a length b between 4¾ inches and 5¼ inches and are separated from each other by a distance c, for example 2 inches, corresponding to the length of transverse members 69. Transverse members 69 are preferably ½ inch in diameter and separated from each other by a distance e of 1½ inches.

Underside 68 of buttocks support 20 is preferably covered with a layer of hardened rubber or plastic. Preferably, base 60 is attached to a pole 40 of bicycle device 12 having a diameter between 2 and 2.5 inches. Pole 40 typically is metal but may be made of another suitable material. The seat mounts currently used in bicycles could serve as suitable seat supports for base 60.

Preferably, first and second sides 24, 26 of buttocks support 20 have a length such that the width w of seat 10 along the x axis is up to 8 inches, preferably between 7 and 8 inches. For example, first and second sides may each be 6 inches with third and fourth sides 28, 30 extending the width of seat 10 to 8 inches. First and second sides 24, 26 are preferably separated by a distance d along y axis up to 5 inches, preferably between 4 and 5 inches, and most preferably 4.5 inches. Buttocks support 20 preferably has a thickness between 1 and 2 inches, for example 1.5 inches, and a circumference between 20 and 30 inches.

A cover 50 may be disposed over buttocks support 20. Cover 50 may comprise a relatively thin layer of cushioning material such as material commonly used for the hand grips on bicycle handlebars or have a greater thickness in which case the thickness of buttock support 20 may be reduced.

Preferably, cover 50 comprises a foam padding material with two rectangular cushion portions 52, 54, for example 2.5 inches by 3.5 inches, disposed over a portion of circumferential area 32. For example, polyurethane foam, rubber or other compressible material may be used to form cover 50. Preferably, outer surface of cover 50 is made of durable material such as nylon. The oval shape of the buttock support and foam padded seating surface is comfortable, aerodynamically sound and allows for easy mounting and dismounting.

The bicycle seat in accordance with the invention totally supports the superior aperture and the inferior aperture of a user's pelvis, which allows the seat to provide more comfort to the buttock area. The seat is designed to be non-restricting, is not constricting with a user's movement in operating the bicycle, and takes into account the full pelvic anatomy of both male and female structures. Moreover, the seat removes the horn or nose of traditional bicycle seats, which has been associated with many health risks and physical injury, and may be used in bicycles designed for speed racing.

While several embodiments of the present invention have been shown and described, it is to be understood that many changes and modifications may be made thereunto without departing from the spirit and scope of the invention as defined in the appended claims.

What is claimed is:

1. A seat for a bicycle device having rotationally mounted pedals comprising:
(a) a buttocks support having a surface for supporting the ischial bones of a user, said surface comprising first and second sides transverse to the ischial bones and third and fourth sides connecting the first and second sides, said surface providing a circumferential area approximately equal to or greater than the area occupied by the buttocks of a user when seated; and
(b) a base connected to the buttocks support for attachment to the bicycle device and positioning of the buttocks support transverse to the rotational plane of the pedals.

2. The seat according to claim 1 wherein the first and second sides have a length between 7 and 8 inches and are separated by a distance between 4 and 5 inches and the buttocks support has a thickness between 1 and 2 inches.

3. The seat according to claim 1 wherein the circumferential area is between 25 and 45 square inches.

4. The seat according to claim 1 further comprising a cover disposed over the buttocks supports, said cover comprising a foam padding material.

5. The seat according to claim 4 wherein the cover has two rectangular cushion portions disposed over a portion of the circumferential area.

6. The seat according to claim 1 wherein the first and second sides are curved.

7. The seat according to claim 1 wherein the third and fourth sides are curved.

8. The seat according to claim 1 wherein the base comprises a brim connected to an underside edge of said buttocks support, a plurality of braces connected to the brim, and a plurality of rods inserted into said braces.

9. The seat according to claim 8 wherein the brim and the braces are formed from plastic and the rods have a rubber covering.
